(19) United States
(12) Patent Application Publication
(10) Pub. No.: US 2024/0173713 A1
(43) Pub. Date: May 30, 2024

(54) FAULTY UNIT DETECTION SYSTEM AND METHODS

(71) Applicant: Cepheid, Sunnyvale, CA (US)

(72) Inventor: Koohong Chung, Sunnyvale, CA (US)

(21) Appl. No.: 18/460,266

(22) Filed: Sep. 1, 2023

Related U.S. Application Data
(60) Provisional application No. 63/374,312, filed on Sep. 1, 2022.

(51) Int. Cl. B01L 3/00

(52) U.S. Cl. CPC B01L 3/502; B01L 2200/12; B01L 2300/0627

(57) ABSTRACT

Methods and system for identifying faulty sample cartridges in real-time during manufacturing are provided herein. Such systems use monitored operational parameters associated with operation of manufacturing equipment that manufactures the sample cartridges. One or more data sets of operational parameters are obtained from existing equipment controls and/or additional sensors and compared to corresponding operational parameters associated with acceptable cartridges. A faulty detection unit can be configured to compare the operational parameters and can optionally include algorithms and/or models, such as a machine learning model, by which faulty cartridges can be identified. The comparison can include determining whether the monitored operational parameters are within a pre-defined range of acceptable values and/or deviate from a characteristic profile of the operational parameter in a manner indicative of faulty cartridges. The faulty cartridge detection can be integrated within automation controls so that faulty cartridges can be detected in real-time and automatically discarded during manufacturing.

### CROSS-REFERENCES TO RELATED APPLICATIONS

This application is a Non-Provisional of and claims the benefit of priority of U.S. Provisional Application No. 63/374,312 filed on Sep. 1, 2022, which is incorporated herein by reference.

This application is generally related to U.S. Non-Provisional application Ser. No. ______ entitled “Seal Failure Detection System and Methods,” [Atty Docket No. 085430-1406031-008210US] and U.S. Provisional Application ______ entitled “Transfer Learning Methods and Models Facilitating Defect Detection,” [Atty Docket No. 085430-1406033-008310US] filed concurrently herewith, the entire contents of which are incorporated herein by reference for all purposes.

### FIELD OF THE INVENTION

The present invention relates generally to the field of manufacturing, in particular identification of faulty units, such as sample cartridges for analysis of a fluid sample.

### BACKGROUND OF THE INVENTION

In recent years, there has been considerable development in the field of biological testing devices that facilitate manipulate a fluid sample within a sample cartridge to prepare the sample for biological testing by polymerase chain reaction (PCR). One notable development in this field is the GeneXpert sample cartridge by Cepheid. The configuration and operation of these types of cartridges can be further understood by referring to U.S. Pat. No. 6,374,684 entitled “Fluid Control and Processing System,” and U.S. Pat. No. 8,048,386 entitled “Fluid Processing and Control.” While these sample cartridges represent a considerable advancement in the start of the art, as with any precision instrument, there are certain challenges in regard to manufacturing of the sample cartridge, in particular the assembly of multiple components can occasionally result in defects that cause the sample cartridge to leak or unable to maintain internal pressure needed for successful operation.

Conventional systems for manufacturing sample cartridges utilize a series of manufacturing process and steps, some of which employ processes that can introduce defects into the sample cartridge, for example defects that cause the sample cartridge to be unable to maintain internal pressure, commonly known as seal failures. Certain steps, such as welding of a lid apparatus onto a cartridge body and film sealing of reagents in the cartridge occasionally introduce defects in sealing that can be difficult to detect. Existing approaches to detecting these include various seal testing approaches and visual inspections, however, these approaches often utilize destructive methods and/or occasionally fail to identify all defects. Existing testing procedures entail randomly selecting a number of units (e.g. 200 cartridges) produced from the assembly/manufacturing line and performing a specialized seal test (e.g. Seal Test Failure (STF) test). When more than a pre-set number units (e.g. 10 cartridges) fails the test, this results in abandoning the entire lot, which consists of a large volume of units (e.g. 1500 to 1600), as faulty. When these faulty units are not detected during this quality check process, this allow faulty units to reach to the customers.

Accordingly, there exists a need for improved methods of detecting faulty cartridges that avoids needless waste of entire lots and avoids faulty units reaching the customer. There is further need for faulty cartridge detection methods that are non-destructive, that do not require extensive testing post-manufacture and that are not prone to human errors.

[symbol]

### BRIEF SUMMARY OF THE INVENTION

In one aspect, the invention pertains to methods of detecting faulty sample cartridges. Such methods can include steps of: obtaining one or more data sets of one or more monitored operational parameters during a manufacturing process of a sample cartridge; comparing the one or more data sets to a baseline or standard data set of the manufacturing process associated with acceptable sample cartridges; and identifying a faulty sample cartridge based on a variance of the one or more data sets from the baseline or standard data set. In some embodiments, identifying a faulty sample cartridge is based on the monitored operational parameter being outside of a range of acceptable operational values of the parameter associated with approved sample cartridges. The range of acceptable values can vary with respect to time, depending on the manufacturing process. In some embodiments, identifying a faulty sample cartridge is based on the monitored operational parameter diverging from a standard characteristic profile of the operational parameters associated with approved sample cartridges.

In some embodiments, the manufacturing process includes welding of cartridge components by a welder that engages forcibly against the cartridge components, such as a lid and cartridge body, and applies ultrasonic energy to form a weld that seals the components together. The operational parameters can include any of: power, travel distance, force, amplitude, frequency, or any combination thereof. In some embodiments, the operational parameter includes power supplied to the welder during welding. In some embodiments, the operational parameter includes a travel distance of the welder sonotrode during welding. In some embodiments, the operational parameter includes a force applied by the sonotrode during welding. In some embodiments, the operational parameter includes an amplitude of the ultrasound applied during welding. In some embodiments, the operational parameter includes a frequency of the ultrasound applied by the ultrasonic sonotrode during welding. In some embodiments, the manufacturing process includes heat sealing of the cartridge lid by a heat sealing mechanism that presses a film across the lid and applies heat thereby heat sealing openings in the lid to seal reagents in the cartridge. In some embodiments, identifying faulty cartridges includes automatically identifying faulty cartridges based on the one or more data sets obtained from an automated control unit controlling operation of the manufacturing equipment, and the method can further include automatically discarding any faulty cartridge.

In another aspect, the invention pertains to a system configured for detecting faulty sample cartridges. Such systems include one or more sensors in communication with manufacturing equipment, where the sensors monitor operational parameters associated with operation of the manufacturing equipment performing a manufacturing process on the sample cartridge; and a processing unit communicatively coupled to the one or more sensors. The processing unit has recorded thereon instructions for performing automated detection of faulty sample cartridges that includes steps of: obtaining one or more data sets of the one or more monitored operational parameters from the one or more sensors during a manufacturing process of a sample cartridge; comparing the one or more data sets to a baseline data set of the manufacturing process associated with acceptable sample cartridges; and identifying a faulty sample cartridge based on a variance of the one or more data sets from the baseline data set. In some embodiments, the one or more sensors are integrated within a control unit that operates the manufacturing equipment. In some embodiments, the system is integrated within automation software that controls the manufacturing processes and associated manufacturing line and the system is configured to automatically discard any faulty cartridges during manufacturing. In some embodiments, the processing unit is configured such that identification of a faulty sample cartridge is based on the monitored operational parameters being outside of a range of acceptable operational values of the parameter associated with approved sample cartridges. The range of acceptable values can vary with respect to time. In some embodiments, the processing unit is configured such that identifying a faulty sample cartridge is based on the monitored operational parameter diverging from a characteristic profile of operational parameters associated with approved sample cartridges.

In some embodiments, the manufacturing process includes welding of cartridge components by a welder that engages forcibly against cartridge components, such as a lid and cartridge body, and applies ultrasonic energy to form a weld that seals the components together. In some embodiments, the operational parameters include any of: power, travel distance, force, amplitude, frequency, or any combination thereof. In some embodiments, the operational parameter includes power supplied to the welder during welding. In some embodiments, the operational parameter a travel distance of the welder sonotrode during welding. In some embodiments, the operational parameter includes a force applied by the sonotrode during welding. In some embodiments, the operational parameter includes an amplitude of the ultrasound applied during welding. In some embodiments, the operational parameter includes a frequency of the ultrasound applied by the ultrasonic sonotrode during welding. In some embodiments, the manufacturing process includes heat sealing of the cartridge lid by a heat-sealing mechanism that presses a film across the lid and applies heat thereby heat sealing the film atop the lid. In some embodiments, the processing unit is configured such that the defect detection is determined in real-time during manufacturing of the sample cartridge. In some embodiments, processing unit is configured to command the system to discard a faulty cartridge from the manufacturing line once identified.

### BRIEF DESCRIPTION OF THE DRAWINGS

FIG. 1A is a flowchart of a faulty cartridge detection that utilizes inputs of monitored operational parameters of a manufacturing process compared to corresponding parameters of acceptable cartridges to identify faulty cartridges, according to some embodiments.

FIG. 1B is a flowchart demonstrating another faulty cartridge detection approach that utilizes inputs of operational parameters of a manufacturing process within a machine learning model that analyzes the parameters relative corresponding parameters of acceptable cartridges in order to identify faulty cartridges, in accordance with some embodiments.

FIG. 2A illustrates an exemplary sample cartridge having a welded lid apparatus and film seal, as provided to the user, with the lid in the top lid open for receiving a fluid sample. FIG. 2B illustrates an exploded view of the sample cartridge illustrating its major components, including the lid apparatus, multi-chamber body, reaction vessel, valve assembly and base, in accordance with some embodiments. FIGS. 2C-2D show a detail view of the lid apparatus. FIG. 2E shows the lid apparatus before placement atop the sample cartridge body for ultrasonic welding by the welding horn. FIG. 2F shows a schematic of a portion of the manufacturing line process and associated operational parameters used for automated detection of faulty cartridges in accordance with the methods described herein.

FIGS. 3A-3B illustrates a manufacturing process flow chart and examples that show various sources of cartridge defects in an exemplary manufacturing method of sample cartridges that may result a faulty cartridge, as identified by the methods herein.

FIG. 4 illustrates a data collection flowchart during a manufacturing process including operational parameters from welder operation that can be utilizing in automated detection of faulty cartridges, in accordance with some embodiments.

FIGS. 5A-9B illustrate monitored operational parameters during a manufacturing process of welding a lid apparatus to the cartridge body, each showing operational parameters of three faulty cartridges at left as compared to standard or baseline operational parameters of acceptable cartridges at right, in accordance with some embodiments.

FIGS. 10-11 show faulty cartridge detection method per some embodiments.

### DETAILED DESCRIPTION OF THE INVENTION

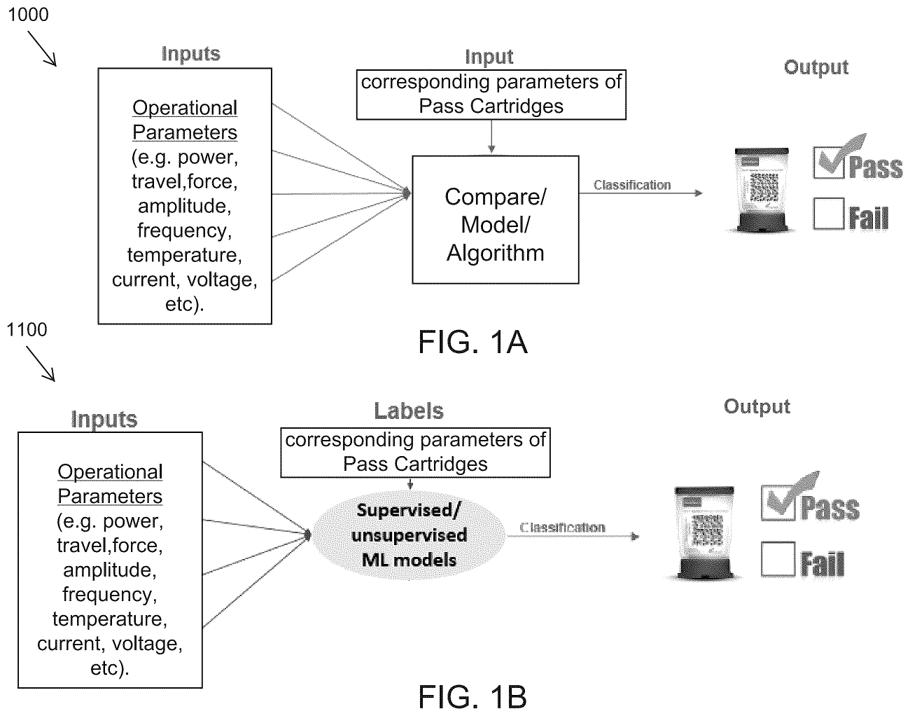

The present invention relates generally to manufacturing defect detection, particularly identification of faulty sample cartridges during manufacturing. In some embodiments, the methods and systems provide automated identification of faulty cartridges that is performed in real-time during manufacturing. Flowcharts of such automated faulty cartridge identification methods are shown in FIG. 1A-1B discussed in further detail below.

### I. System Overview

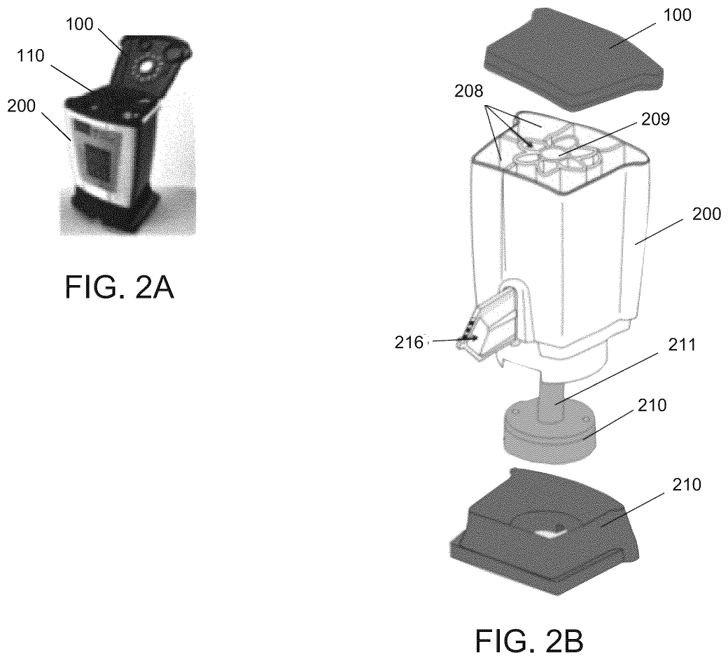

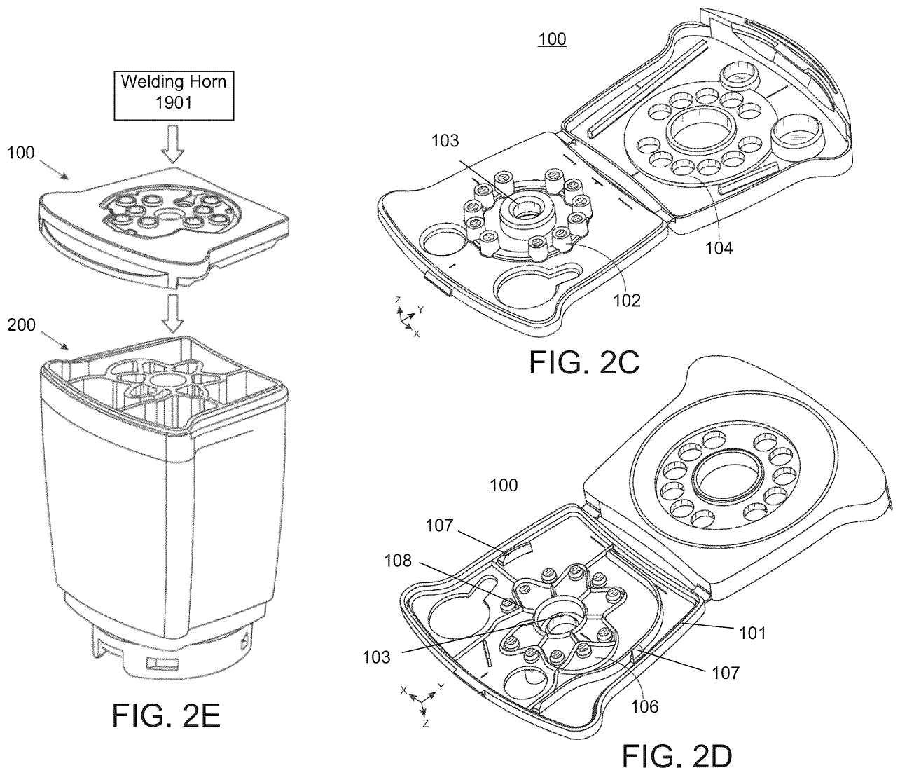

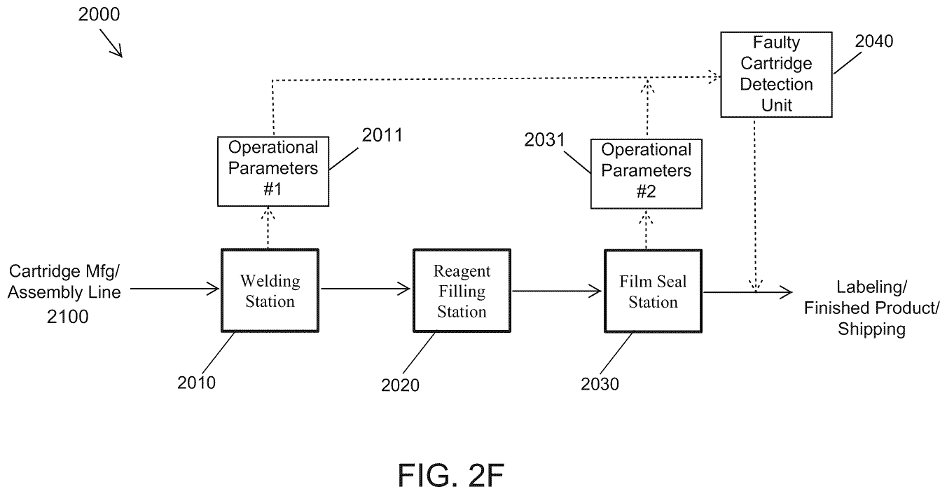

In one aspect, the invention pertains to an automated detection system for identifying faulty sample cartridge. An exemplary sample cartridge configured for testing for a target analyte is shown in FIG. 2A. The sample cartridge includes a lid apparatus 100 sealed atop the cartridge body 200 that holds the reagents and a fluid sample. The lid apparatus 100 includes a bottom lid portion that is sealed to the cartridge body and a top lid portion that flips open, as shown, to allow the user to deposit a fluid sample in the cartridge. The sample cartridge is provided to the user having reagents already disposed within selected chambers and sealed within the cartridge by a thin film 110 sealed atop the bottom lid. The thin film includes a central opening for the syringe and an opening for insertion of the fluid sample.

FIG. 2B depicts an exemplary cartridge suitable for performing a multi-target panel assay, as described herein. The illustrated cartridges are based on the GENEXPERT® cartridge (Cepheid, Inc., Sunnyvale, Calif.). The cartridge 100 comprises a cartridge body 200 having multiple chambers 208 defined therein for holding various reagent and/or buffers. The chambers are disposed around a central syringe barrel 209 that is in fluid communication with valve body 210 through valve syringe tube 211 extending through the syringe barrel 209. The valve body 210 is interfaced within the cartridge body and supported on a cartridge base 210. The cartridge typically contains one or channels or cavities that can contain a filter material (e.g. glass filter column) that can function to bind and elute a nucleic acid. In various embodiments, the cartridge further comprises one or more temperature controlled channels or chambers that can, in certain embodiments, function as thermocycling chambers. A “plunger” not shown can be operated to draw fluid into the syringe barrel 209 and rotation of the valve body/syringe tube provides selective fluid communication between the various reagent chambers and channels, reaction chamber(s). Thus, the various reagent chambers, reaction chambers, matrix material(s), and channels are selectively in fluid communication by rotation of the valve and plunger and reagent movement (e.g., chamber loading or unloading) is operated by the “syringe” action of the plunger. The attached reaction vessel 216 (“PCR tube”) provides optical windows to provide real-time detection of, e.g., amplification products, base identity in sequencing operations, by operation of the module within the system described herein. It is appreciated that such a reaction vessel could include various differing chambers, conduits, or micro-well arrays for use in detecting the target analyte. The sample cartridge can be provided with means to perform preparation of the biological fluid sample before transport into the reaction vessel. Any chemical reagent required for viral or cell lysis, or means for binding or detecting an analyte of interest (e.g. reagent beads) can be contained within one or more chambers of the sample cartridge, and as such can be used for sample preparation.

An exemplary use of such a sample cartridge with a reaction vessel for analyzing a biological fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of the sample cartridge and associated instrument module are shown and described in U.S. Pat. No. 6,374,684, entitled “Fluid Control and Processing System” filed Aug. 25, 2000, and U.S. Pat. No, 8,048,386, entitled “Fluid Processing and Control,” filed Feb. 25, 2002, the entire contents of which are incorporated herein by reference in their entirety for all purposes. Various aspects of the sample cartridge can be further understood by referring to U.S. Pat. No. 6,374,684, which described certain aspects of a sample cartridge in greater detail. Such sample cartridges can include a fluid control mechanism, such as a rotary fluid control valve, that is connected to the chambers of the sample cartridge. Rotation of the rotary fluid control valve permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module comprises a motor such as a stepper motor typically coupled to a drive train that engages with a feature of the valve to control movement of the valve in coordination with movement of the syringe, thereby resulting in movement of the fluid sample according to the desired sample preparation protocol. The fluid metering and distribution function of the rotary valve according to a particular sample preparation protocol is demonstrated in U.S. Pat. No. 6,374,684.

FIGS. 2C-2D shows a detailed view of the exemplary lid apparatus 100, which includes a central opening for passage of the syringe/plunger, which effects movement of fluids between the chambers, and the central opening is surrounding by a plurality of chimneys 102 (with passages) that protrude into openings 104 in the top lid. Accordingly, the lid apparatus 100 includes a substantially uniform bottom-surface 106, and thus the shown inner welding pattern is not coextensive with any walls that extend from the bottom-surface 106. The chambers of the fluid container apparatus disclosed herein can contain one or more reagents for a variety of purposes. These reagents maybe present in a variety of forms. Non-limiting exemplary reagent forms can include a solution, a dry powder, or a lyophilized bead. The reagents may be intended for different purposes including but not limited to chemical and/or enzymatic reactions, sample preparation, and/or detection. Non-limiting exemplary purposes can include lysis of cells or microorganisms, purification or isolation of an analyte of interest (e.g., a specific cell population, a nucleic acid or a protein), digestion or modification of nucleic acids or proteins, amplification of nucleic acids, and/or detection of an analyte of interest. Additional details of the lid apparatus can be found in U.S. Pat. No. 10,273,062, the entire contents of which are incorporated herein by reference for all purposes.

FIG. 2C shows a top view of the lower-side of bottom-lid and underside of the top-lid portion. The lower-side of bottom-lid includes a plurality of chimneys 102 that protrude upwards from the top surface of the bottom-lid portion and are received in corresponding holes 104 in the top-lid portion. The plurality of chimneys 102 and openings 104 surround a central opening 103 through which a syringe instrument of the module extends during operation of the sample cartridge therein to facilitate fluid flow between the chambers by movement of the valve body. FIG. 2D shows a bottom view of the lower-side of bottom-lid of lid apparatus 100, which includes a lower-side main surface, and a top-side of the top-lid portion. The underside of the bottom-lid portion is welded onto the top edge of the cartridge body. To facilitate welding, a raised welding ridge 101 is continuous about the periphery of the bottom-lid, between the edge alignment features 107 and the outermost wall. When seated in a proper fashion, the edge alignment features 107 and outermost walls prevent excessive rotation of the bottom-lid against the fluid container 200, thus aligning the raised welding ridge 101 of the bottom-lid with weldable features (e.g., top edges of walls) of the cartridge body. A plurality of walls 108 extend from a central portion of the lower-side main surface. The walls are patterned in a flower petal-like arrangement, about the central opening 103. Here, the walls are formed as six petals. A raised welding pattern is present on the top edges of the walls. The raised welding pattern connects to the welding ridge 101. In this manner, fluidic zones are created outside the petals. When a fluid container and the bottom-lid are welded via the raised welding pattern and welding ridge, sub-containers within the bottom container are fluidly isolated from one another (at least at the interface between the fluid container and the bottom-cap).

FIG. 2E shows the lid apparatus 100 in relation to the cartridge body 200. The cartridge body 200 contains a plurality of chambers that can be fluidly coupled or non-coupled according to the position of an internal valve assembly. The chambers are defined by walls that extend to the top of the cartridge body 200. The fused interface between the lid apparatus 100 and the cartridge body 200 is created such that the chambers are sealed off from one another by way of a welded interface between the raised welding pattern 160 and welding ridge 156 and the chambers of the container 200. The lid apparatus 100 is welded to the fluid container by way of an ultrasonic welding horn 1901 that interfaces with the lid while the lid is seated on the container 200. The welding horn 1901 generally comprises a metal cylinder shaped to interface against and around the plateau. The welding horn is part of a greater welding apparatus (not shown) which provides energy to the horn. In an exemplary welding process, the lid apparatus is placed atop the cartridge body such that the welding ridges are aligned with the top edges of the cartridge body. Next, the ultrasonic welding horn is pressed down atop the lid and with sufficient force applied to increase contact forces for welding and ultrasonic energy is applied to facilitate ultrasonic welding. The operational parameters associated with this welding process include the power (W) supplied to the welder, the travel distance (mm) the ultrasonic horn travels during welding, the force (N) applied by the ultrasonic horn, the amplitude (%) of ultrasonic energy applied, and the frequency (Hz) of ultrasonic energy applied by the ultrasonic horn. It is appreciated that some embodiments, the detection methods may utilize only one or a subset of these monitored parameters. In some embodiments, these parameters are already monitored by the equipment controller in their standard operation such these parameters can be used to detect faulty cartridge without requiring any additional sensors. To the extent any of these parameters are not already monitored, one or more additional sensors can be included to monitor these or other operational parameters. A commercially available ultrasonic welding apparatus, available from manufacturers such as Hermann Ultrasonics, Bartlett, III. 60103 or Branson Ultrasonics, a division of Emerson Industrial Automation, Eden Prairie, Minn. 55344, can be used in this process. Typically, the welding operation described above is performed at a welding station along the manufacturing/production line of the sample cartridge.

FIG. 2F shows a schematic of a portion of the cartridge manufacturing/assembly line 2100 that includes the welding station 2010, reagent filling station 2020, and the film seal station 2030. At the welding station, an automated alignment fixture places the lid apparatus 100 atop the cartridge body 200 and an automated ultrasonic horn is pressed down and ultrasonic energy applied for at least 3-5 seconds so as to weld the lid to the cartridge body by ultrasonic welding. As described above, the welding ridges on the underside of the bottom lid are shaped and designed to be sealingly welded to the top edges of the cartridge body chambers. After welding, the cartridge is moved in an automated sequence to the reagent filling station where one or more reagents (e.g. beads, fluids, powder, etc.) or other process materials (e.g. buffers, desiccants) are deposited in select chambers through the chimney openings within the lid. After the reagents or other process materials are placed in the chambers, a thin film seal is applied to the top surface of the bottom lid so as to seal the chimney passage openings, thereby sealing the reagents and process materials inside the cartridge. Automated equipment places a thin film atop the bottom lid (the lid being in the open configuration) and applies heat so as to seal the thin film onto the bottom lid portion. The thin film includes a central aperture (e.g. cross-cut) to allow passage of the syringe of the instrument module through the film, and another opening on the lower right to allow injection of the fluid sample by the user into a sample chamber, however, the remaining openings in the lid that include the chimney openings to the chambers with reagents and process materials are sealed by the thin film seal.

As described further below, the automated faulty cartridge detection system obtains one or more operational parameters 2011 from the welder, which are then input into a faulty cartridge detection unit 2040 which compares the parameters with corresponding operational parameters from acceptable cartridges (e.g. a number of cartridges having passed applicable performance tests). While these concepts are described with respect to the manufacturing process of welding, it is appreciated that these same concepts can be applied to various other manufacturing processes, including but not limited to film heat sealing of the reagents in the cartridge body at the film seal station. Similarly, this second data set of operational parameters 2031 from the film station can be input to the faulty detection unit to identify faulty cartridges due to defects in the film seal. This identification from both inputs can be output back into the manufacturing line to allow discarding of faulty cartridges before labelling and completion of the cartridges and shipping to the consumer.

### II. Example Detection Methods

### A. Overview

In one aspect, the system and methods described herein utilize one or more monitored operational parameters associated with performing one or more manufacturing processes along the manufacturing production line to identify faulty cartridges in-real time during manufacturing. The monitored parameters can be obtained from existing control units that control operation of the manufacturing equipment, using sensors integral to the equipment, or can be obtained by additional sensors. In some embodiments, corresponding parameters from acceptable cartridges can be used to determine a baseline range or profile for a given parameter. In other embodiments, a more complex relationship between multiple parameters can be examined by use of specially developed algorithms. Given the complexity of data and the limited amount of data associated with defects (which are relatively infrequent), it can be advantageous to utilize a machine learning (ML) model to determine a relationship between one or more monitored parameters and faulty cartridges. By utilizing a ML model, subtle variations in monitored parameters that contribute to defects resulting in faulty cartridges can be examined. Advantageously, this automated defect detection allows for identification of faulty cartridges in real-time during manufacturing, so the cartridge can be removed during manufacturing. In some embodiments, the automated defect detection avoids the need to conduct destructive post-manufacturing testing on select cartridge from each lot, particularly destructive testing, thereby avoiding waste and reducing costs, while considerably improving defect detection.

### B. Example Faulty Cartridge Detection

In one aspect, one objective of this invention was to develop a supervised model based on power (P), travel (T), force (F), amplitude (A), and frequency (Y) data that are reported from the automated welder data (e.g. Hermann Welder data) during the welding process along the automated manufacturing line (e.g. Reagents On-Board Assembly Line (ROBAL)). In conventional systems, the automated welder data is reported in these five parameters in 1 milli-second resolution. This data shows how much power had been supplied to the welder and how much the lid of the cartridge had been moved as well as how much force had been applied by the ultrasonic welder (e.g. sonic rod or horn). When not enough distance (i.e., travel) is reported, this can indicate improper welding and discrete movement of force or amplitude can also indicate improper welding which can lead to failing Seal Test Failure (STF) associated with faulty cartridges. As noted previously, existing procedure requires abandoning entire lot when excessive number of units fail STF testing and more importantly allow faulty unit to reach our customers. Thus, by developing a supervised model allows for automated faulty cartridge detection that can detect faulty units in real-time to improve product quality and prevent waste associated with abandoning an entire lot.

In some embodiments, the automated faulty detection unit compares monitored operational parameters with corresponding operational parameters of acceptable cartridges. In some embodiments, the fault detection unit can use an algorithm that is determined by analyzing monitored parameters from a sufficient number of acceptable cartridges until the values of the parameter converge on an identifiable range or characteristic profile. In some embodiments, a ML model can be used to associate one or more parameters of a manufacturing process with a particular defect that contributes to faulty cartridges. In some embodiments, the defects are associated with welded seals (e.g. overweld, underweld, cracked chimney) and/or film seals (e.g. incomplete seal, melted chimney). The parameters or characteristics can include any attribute associated with the manufacturing process. Advantageously, this approach allows for defect detection in real-time during the manufacturing process such that the defective cartridges can be removed mid-process.

As shown in FIG. 1A, schematic 1000 depicts an automated method that obtains one or more inputs of any number of parameters associated with manufacturing processes. In this embodiment, the parameters can be any parameter associated with operating of equipment in a manufacturing process, for example, power, travel, force, amplitude, frequency, temperature, current, voltage. These parameters are fed as inputs into a comparator that compares the parameters with corresponding parameters of acceptable cartridges. The comparator can utilize a model or algorithm specifically developed for faulty cartridge detection based on associations of the parameters and cartridge or process defects. Preferably, the comparison of parameters is performed in real-time during manufacturing so that cartridges determined to be faulty can be removed from the production line. The automated faulty cartridge identification methods described herein can complement or replace standard testing and inspection by personnel.

As shown in FIG. 1B, schematic 1100 depicts an automated method that feeds the inputs of the parameters into a ML model, which can include supervised and/or unsupervised learning. This approach can identify complex relationships between parameters that are associated with defects contributing to faulty cartridges. Given the complexity of data and the various parameters examined, this approach can realize relationships between the various parameters and identify faulty cartridges that may not be realized otherwise or indicated by standard testing and inspection procedures.

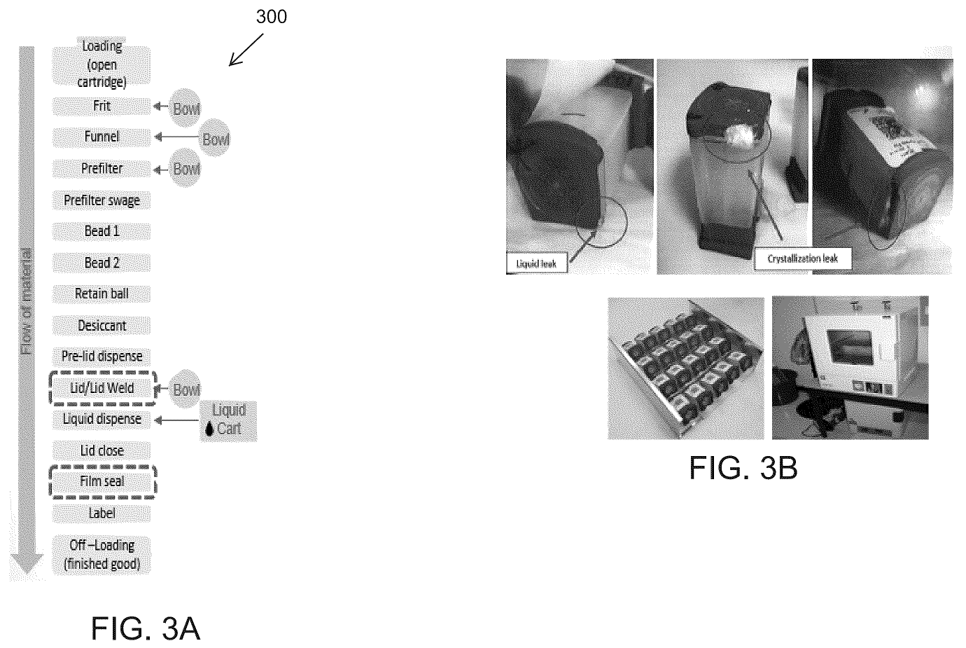

FIG. 3A shows a cartridge assembly workflow 300 that highlight various sources of cartridge defects contributing to faulty cartridges. An exemplary manufacturing process flow is shown at left. The process flow includes the lid welding and film seal steps that are often associated with defects that cause seal test failures associate with faulty cartridges. For example, 80% of seal test failures (STF) can be traced to the lid welding step (e.g. either under or over welding), and about 20% of seal test failures can be traced to the film seal step. Currently, defects caused by these steps are not detected until after the sample cartridges are labelled and off-loaded as a finished product, either by visual inspection by personnel or in a STF or functional test, which can result in a partial or full lot scrap. Accordingly, the automated faulty cartridge detection systems and methods described herein can avoid this waste by allowing for detection of faulty cartridge in real-time before the product manufacturing is completed by analyzing the operational parameters associated with these manufacturing process steps. Thus, this approach described herein allows for improved defect detection, with minimal or no adjustment to the existing manufacturing line. FIG. 3B shows example cartridge defects (e.g. liquid leak, crystallization leak), cartridges and manufacturing equipment.

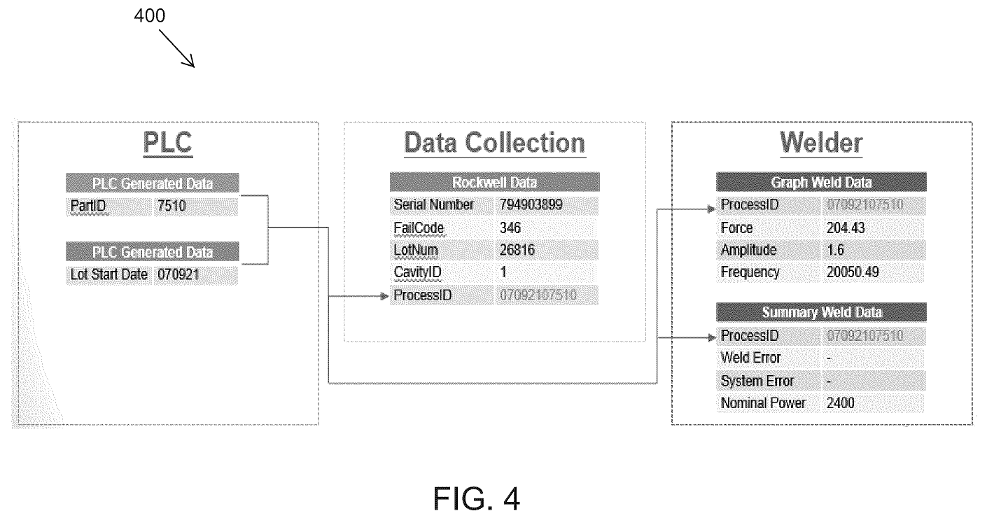

FIG. 4 shows a flowchart 400 that details one approach of integration existing controller parameters for use in automatic faulty cartridge detection. FIG. 4 shows how programmable logic controller (PLC) data is matched to welder data. In conventional systems, there is often no unique identifier matching automation data (e.g. Rockwell database) and welder data (e.g. Hermann welder data). During the weld process, the welder creates and assigns a Process ID to each weld. By combining a Part ID and lot state data, a unique Process ID can be created in the PLC and written to the welder by which the automation data can be matched to the welder data. It is appreciated this is but one approach by which to implement the automated faulty cartridge detection method within existing manufacturing process data flow and it is understood that various other approaches could be used.

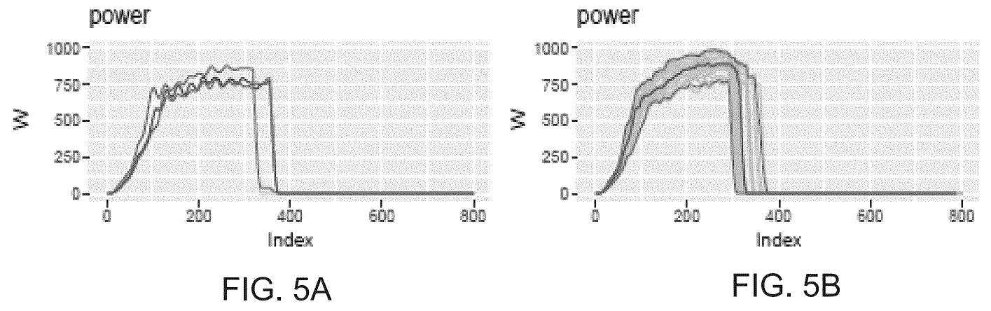

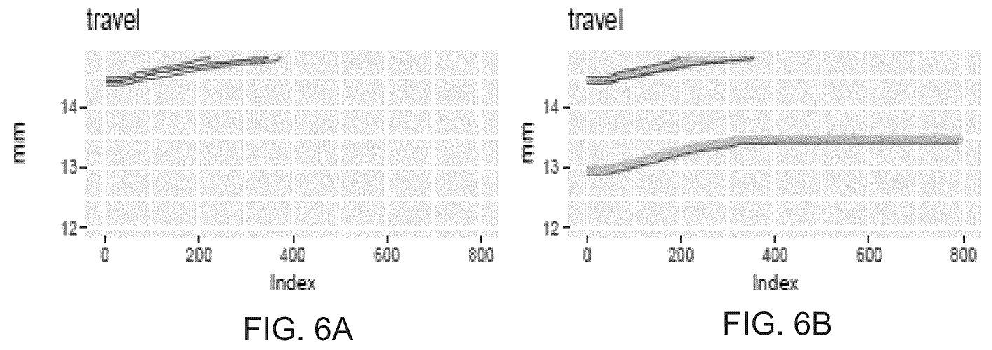

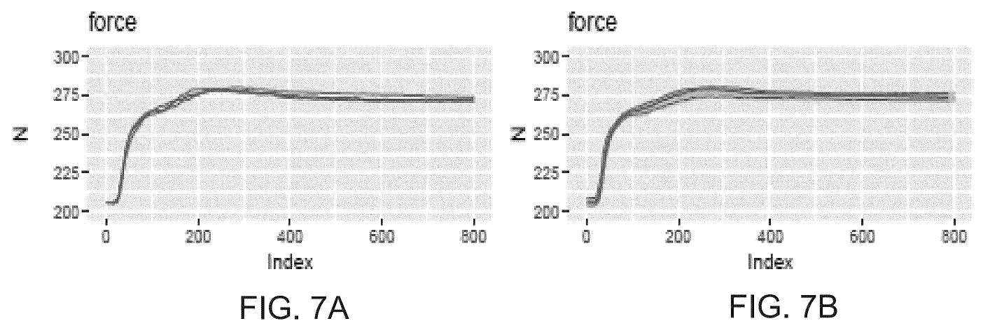

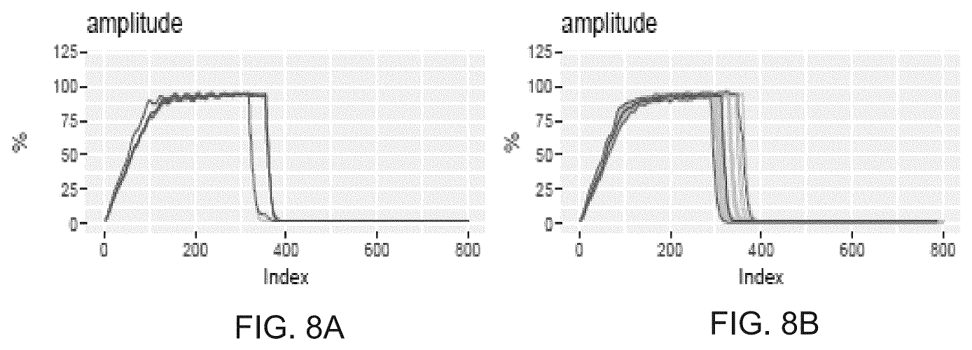

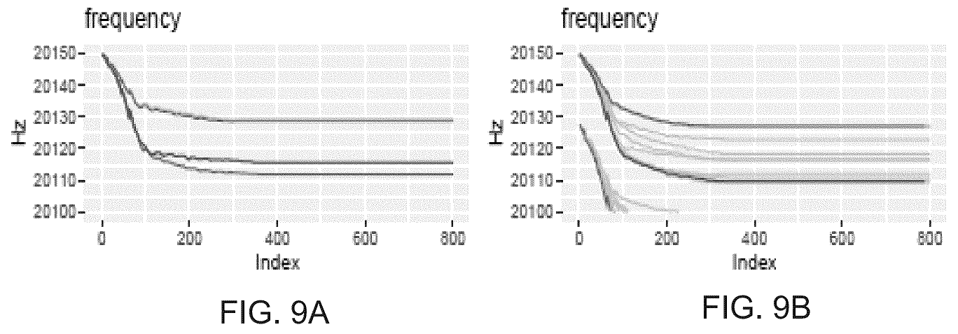

FIGS. 5-9 illustrates monitored operational parameters during a welding manufacturing process of welding the lid apparatus to the cartridge body. The figures shown on the left, FIG. 5A, 6A, 7A, 8A and 9A, are the data observed from three units that failed STF test and the figures shown on the right, FIGS. 5B, 6B, 7B, 8B and 9B, are units that passed the STF test. Each shows the upper and lower bounds of the parameter (indicated in red) as well as the average profile (indicated in blue). For example, the two red lines can indicate a 99.5% confidence interval of the associated parameter. FIG. 5 shows the variation in power (W) supplied to the welder during welding. FIG. 6 shows a variation in travel distance (mm) of the welder during welding. FIG. 7 shows the variation in force (N) applied by the welder during welding. FIG. 8 shows a variation in amplitude (%) of the ultrasound applied by the welder during welding. FIG. 9 shows the frequency (Hz) of the ultrasound applied by the welder during welding. It is considered that inconsistencies in the welding operation (e.g. misalignment, extra lid) or the product materials (e.g. cracked/melted lid, damaged cartridge) result in deviations of one or more of these parameters from the baseline or standard profile and/or range such that a faulty cartridge can be identified if the monitored parameter is outside the standard range of values and/or profile of the parameter associated with acceptable cartridges. It is appreciated that this is not always case, and that development of specialized algorithms can further improve analysis of variations in the monitored parameters associated with faulty cartridges. In some embodiments, a model can be developed for use in identifying faulty cartridges from the monitored parameters associated with manufacture of acceptable cartridges and those associated with faulty cartridges.

Based on available parameter data, one proposed model can be developed according to the following sequence: (1) Continue collecting data, n, until the variations in power (P), travel (T), force (F), amplitude (A), and frequency (Y) data converges. (2) Develop empirical distribution function of normal P, T, F, A, and Y, NP, NT, NF, NA, and NY respectively. (3) Compare the normal curves with real-time P,T,F,A, and Y, compute the difference for each cartridge serial number, i : DPi, DTi, DFi, DAi, DYi (4) Find the distribution of DPi, DTi, DFi, DAi, DYi and compute their p-values: PPi, PTi, PFi, PAi, PYi; (5) Create size 5 vector with these five p-values associated with each of the cartridge (6) Run supervised model based on these features with labelled data.

Based on available parameter data, another proposed model can be developed according to the following sequence: (1) generating a baseline vector from welding data associated with a welder used to attach the lid to the body; (2) collecting attachment data associated with the welder during attachment of the lid to the body; (3) converting the attachment data to a container vector; (4) determining a manufacturing status by comparing the container vector to the baseline vector; and (5) transmitting the manufacturing status to an output.

One or more methods can be performed via a non-transitory computer-readable medium having stored thereon instructions that, when executed by a processor, cause the processor to perform the method. The method can be used to detect manufacturing defects of a container, cartridge, or storage vessel in real time. Additionally, the output communicates a status, a result, information, instructions, or combinations thereof to a user or a device. The output can be auditory, visual, haptic, or combinations thereof. The output can be, for example, a screen, a speaker, an interface, or the like.

Existing auto feature generating models do not generally consider the shape of time series model but generate thousands of features that do not necessarily have physical meaning and can result in over-fitting the model. The proposed model takes the physical meaning of the data into account and creates custom features prior to developing the supervised model. Based on the custom-built features, the drift in welding parameters can also be monitored and accounted for in identifying faulty cartridges. It is noted that not all abnormal patterns associated with power (P), travel (T), force (F), amplitude (A), and frequency (Y) parameters resulted in faulty cartridges (e.g. seal test failures), and that additional relationships between parameters can be examined. It is appreciated that the above approach is but one example to developing a model of the applicable parameters and that various other approaches could be realized. In some embodiments, the various parameters can be input into a ML model so as to develop algorithms that illustrate a relationship between one or more parameters and faulty cartridges, as well as a relationship between multiple differing parameters and faulty cartridges in order to further improve faulty cartridge detection.

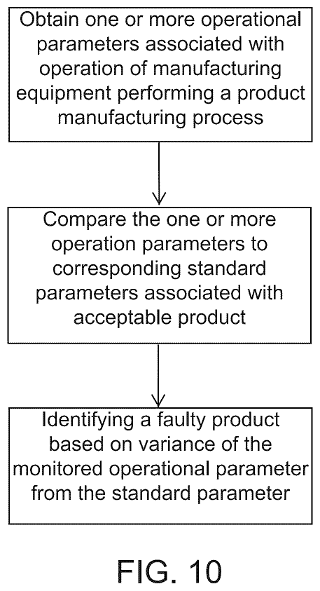

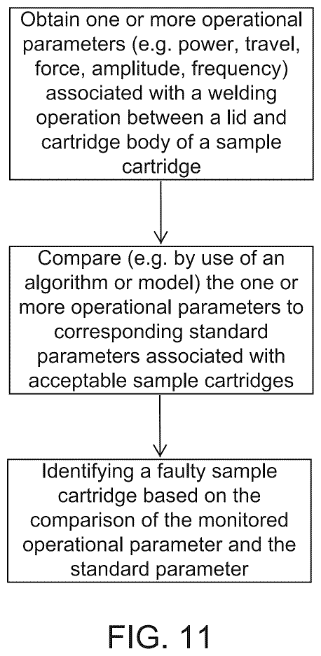

FIGS. 10-11 show exemplary faulty cartridge detection methods, in accordance with some embodiments. FIG. 10 shows a method by which the concepts herein can be applied to detect a faulty product, which can include a sample cartridge as well as various other manufactured products. The method includes steps of: obtaining one or more operational parameters associated with operation of manufacturing equipment performing a product manufacturing process; comparing the one or more operational parameters to corresponding baseline or standard parameters associated with acceptable products; and identifying a faulty product based on variance of the monitored operational parameter from the baseline or standard parameter. FIG. 11 shows the method applied to detection of faulty sample cartridges, as described herein. The method includes steps of: obtaining one or more operational parameters (e.g. power, travel, force, amplitude, frequency) associated with a welding operation between a lid and cartridge body for a sample cartridge; comparing (e.g. by use of an algorithm or model) the one or more operational parameters to a corresponding baseline or standard parameters associated with acceptable sample cartridges; and identifying a faulty sample cartridge based on the comparison of the monitored operational parameter and baseline or standard parameter.

In the foregoing specification, the invention is described with reference to specific embodiments thereof, but those skilled in the art will recognize that the invention is not limited thereto. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. Any references to publication, patents, or patent applications are incorporated herein by reference in their entirety for all purposes.

1. A method of detecting faulty sample cartridges, the method comprising:
obtaining one or more data sets of one or more monitored operational parameters during a manufacturing process of a sample cartridge, wherein the operational parameters are associated with operation of manufacturing equipment performing the manufacturing process;
comparing the one or more data sets to a baseline data set of corresponding parameters of the manufacturing process associated with acceptable sample cartridges; and
identifying a faulty sample cartridge based on a variance of the one or more data sets of the monitored operational parameters from the baseline data set.

2. The method of claim 1 wherein identifying a faulty sample cartridge is based on the monitored operational parameters being outside a range of acceptable operational values of the parameter associated with approved sample cartridges.

3. The method of claim 2 wherein the range of acceptable values varies with respect to time during the manufacturing process.

4. The method of claim 1 wherein identifying a faulty sample cartridge is based on the monitored operational parameter diverging from a characteristic profile of the operational parameters associated with approved sample cartridges.

5. The method of claim 1 wherein the manufacturing process is welding of cartridge components by a welder that engages forcibly against the cartridge components and applies ultrasonic energy to form a weld that seals the components together.

6. The method of claim 5 wherein the manufacturing process is welding of a lid apparatus to a cartridge body to form a weld that seals the lid apparatus to the cartridge body.

7. The method of claim 5 wherein the operational parameters comprise any of: power, travel, distance, force, amplitude, frequency, or any combination thereof.

8. The method of claim 5 wherein the operational parameter comprise power supplied to the welder during welding.

9. The method of claim 5 wherein the operational parameter comprises a travel distance of the welder during welding.

10. The method of claim 5 wherein the operational parameter comprises a force applied by the welder during welding.

11. The method of claim 1 wherein the operational parameter comprises an amplitude of ultrasound applied during welding.

12. The method of claim 1 wherein the operational parameter comprises a frequency of ultrasound applied during welding.

13. The method of claim 1 wherein the manufacturing process is heat sealing of the cartridge lid by a heat-sealing mechanism that presses a film across the lid and applies heat thereby heat sealing the film atop the lid.

14. The method of claim 13 wherein identifying faulty cartridges comprises automatically identifying faulty cartridges based on the one or more data sets obtained from an automated control unit controlling operation of the manufacturing equipment, and the method further comprises automatically discarding any faulty cartridge identified.

15. The method of claim 1 wherein comparing utilizes an algorithm developed from a supervised model of corresponding operational parameters associated with a plurality of acceptable sample cartridges and corresponding operational parameters associated with a plurality of faulty cartridges.

16.-41. (canceled)
